(19) United States
(12) Patent Application Publication
(10) Pub. No.: US 2012/0181882 A1
(43) Pub. Date: Jul. 19, 2012

(54) ELECTRIC MACHINE HAVING AN INTEGRATED ROTOR TEMPERATURE SENSOR

(75) Inventors: Bradley D. Chamberlin, Pendleton, IN (US); David A. Fulton, Anderson, IN (US)

(73) Assignee: REMY TECHNOLOGIES, L.L.C., Pendleton, IN (US)

(21) Appl. No.: 13/007,117

(22) Filed: Jan. 14, 2011

(51) Int. Cl. H02K 9/00; H02K 11/00

(52) U.S. Cl. 310/53; 310/68 C; 310/58

(57) ABSTRACT

An electric machine includes a housing, a stator mounted within the housing, and a rotor rotatably mounted within the housing relative to the stator. The rotor includes a rotor lamination assembly having a plurality of laminations. A temperature sensor is arranged within the housing. The temperature sensor includes a sensing surface configured and disposed to detect a temperature of the rotor.

### BACKGROUND OF THE INVENTION

Exemplary embodiments pertain to the art of electric machines and, more particularly, to an electric machine having an integrated rotor temperature sensor.

Electric machines produce work from electrical energy passing through a stator to induce an electro-motive force in a rotor. The electro-motive force creates a rotational force at the rotor. The rotation of the rotor is used to power various external devices. Of course, electric machines can also be employed to produce electricity from a work input. In either case, electric machines are currently producing greater outputs at higher speeds and are being designed in smaller packages. The higher power densities and speeds often result in harsh operating conditions such as high internal temperatures, vibration and the like. Accordingly, many conventional electric machines include sensors that monitor, for example stator temperature, housing temperature and the like. The sensors typically take the form of temperature sensors that are mounted to a housing of the electric machine. The sensors include a separate wiring harness that is coupled to, for example, a controller that reads and/or records sensed data.

### BRIEF DESCRIPTION OF THE INVENTION

Disclosed is an electric machine that includes a housing, a stator mounted within the housing, and a rotor rotatably mounted within the housing relative to the stator. The rotor includes a rotor lamination assembly having a plurality of laminations. A temperature sensor is arranged within the housing. The temperature sensor includes a sensing surface configured and disposed to detect a temperature of the rotor.

Also disclosed is a method of operating an electric machine. The method includes rotating a rotor relative to a stator, and measuring a temperature of the rotor with a temperature sensor integrated into the electric machine.

### BRIEF DESCRIPTION OF THE DRAWINGS

The following descriptions should not be considered limiting in any way. With reference to the accompanying drawings, like elements are numbered alike:

FIG. 1 depicts an electric machine including an integrated temperature sensor in accordance with an exemplary embodiment;

FIG. 2 depicts an electric machine including an integrated temperature sensor in accordance with another aspect of the exemplary embodiment; and

FIG. 3 depicts an electric machine including an integrated temperature sensor in accordance with yet another aspect of the exemplary embodiment.

### DETAILED DESCRIPTION OF THE INVENTION

A detailed description of one or more embodiments of the disclosed apparatus and method are presented herein by way of exemplification and not limitation with reference to the Figures.

Exemplary embodiments provide a temperature sensor that is integrated directly into an electric machine. The temperature sensor is positioned adjacent to a rotor. The temperature sensor provides feedback relating to rotor temperature. Monitoring rotor temperature enhances machine reliability by providing an indicator of a potential failure mode. That is, operating parameters of the electric machine can be adjusted based on rotor temperature to avoid a potential rotor fault such as demagnetization of magnets. Also, integrating the temperature sensor into the electric machine eliminates any need for additional wiring harnesses or additional external connections that increase cost, complexity, and an overall number of potential failure points. Monitoring rotor temperature enhances operational control of an electric machine. Torque in an interior permanent magnet (IPM) machine includes two parts, permanent magnet (PM) torque and reluctance torque. Torque in the IPM machine is tied to magnet temperature. An increase in magnet temperature requires a different control point to achieve maximum torque.

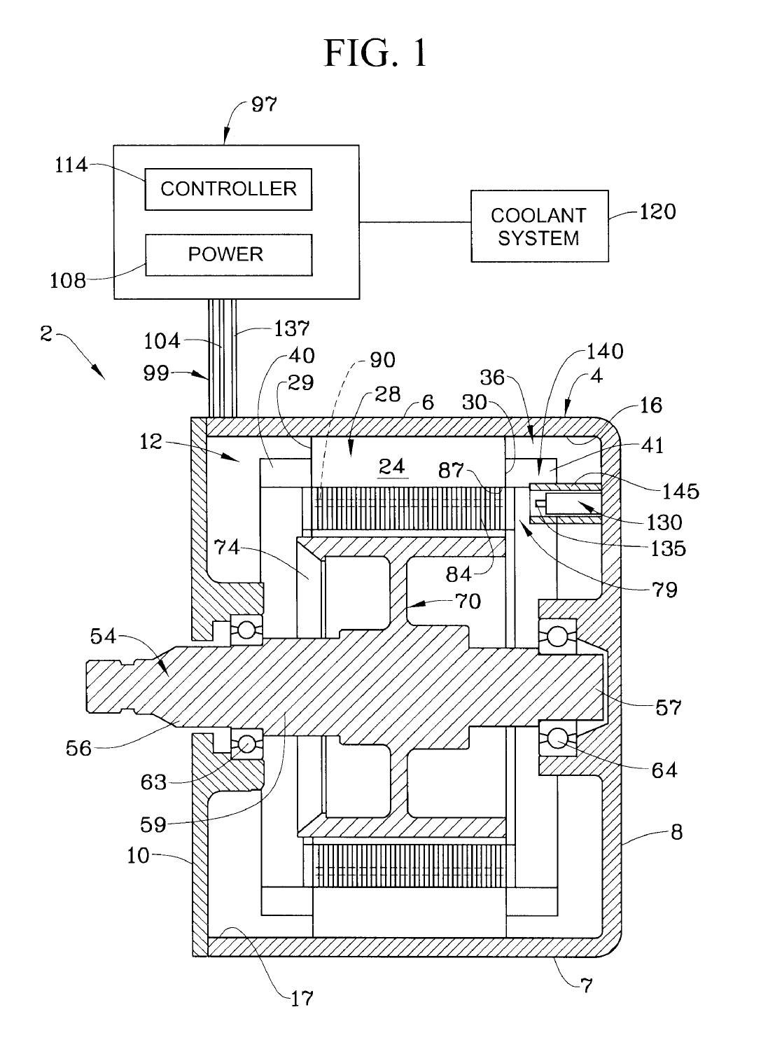

An electric machine in accordance with an exemplary embodiment is indicated generally at 2 in FIG. 1. Electric machine 2 includes a housing 4 having first and second side walls 6 and 7 that are joined by a first end wall 8 and a second end wall or cover 10 to collectively define an interior portion 12. First side wall 6 includes an inner surface 16 and second side wall 7 includes an inner surface 17. At this point it should be understood that housing 4 could also be constructed to include a single side wall having a continuous inner surface. Electric machine 2 is further shown to include a stator 24 arranged at inner surfaces 16 and 17 of first and second side walls 6 and 7. Stator 24 includes a body 28, having a first end portion 29 that extends to a second end portion 30, which supports a plurality of windings 36. Windings 36 include a first end turn portion 40 and a second end turn portion 41.

Electric machine 2 is also shown to include a shaft 54 rotatably supported within housing 4. Shaft 54 includes a first end 56 that extends to a second end 57 through an intermediate portion 59. First end 56 is rotatably supported relative to second end wall 10 through a first bearing 63 and second end 57 is rotatably supported relative to first end wall 8 through a second bearing 64. Shaft 54 supports a rotor 70 that is rotatably mounted within housing 4. Rotor 70 includes a hub 74 that is fixed relative to intermediate portion 59, and a rotor lamination assembly 79. Rotor lamination assembly 79 includes a plurality of laminations, one of which is indicated at 84. In the exemplary embodiment shown, electric machine 2 takes the form of an interior permanent magnet (IPM) machine such that laminations 84 include a series of permanent magnets 90 and are stacked and aligned to define an outer diametric surface 87 of rotor lamination assembly 79. Of course it should be understood that electric machine 2 can take a variety of forms.

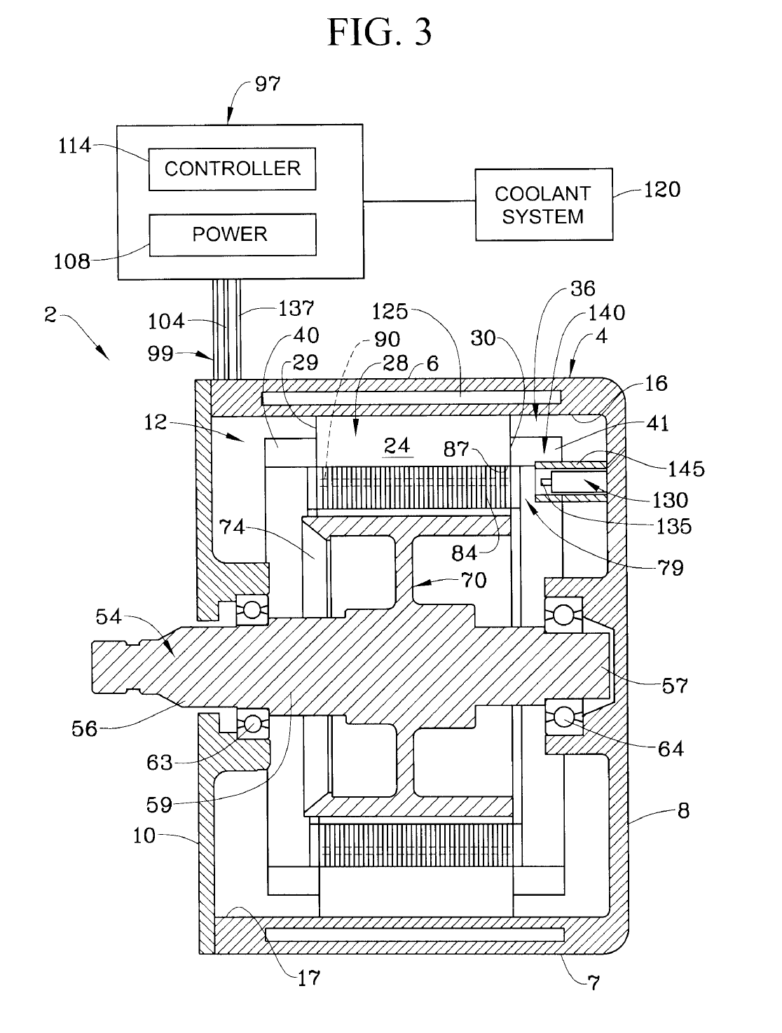

Electric machine 2 is electrically connected to a motor control panel 97 through a power cable 99 that includes a plurality of power conductors, one of which is indicated at 104, that electrically couple stator 24 with a power source 108 having terminals (not shown) arranged in motor control panel 97. Motor control panel 97 also houses a controller 114 that may be employed to control motor starting, motor speed, and/or motor shut down, as well as various other operating parameters. In the exemplary embodiment shown, controller 114 is linked to a coolant system 120 that delivers a flow of coolant, such as oil, airflow or the like, through housing 4. By “through” it should be understood that coolant system 120 can not only be configured to direct a flow of coolant directly into housing 4 and/or onto first and second bearings 63 and 64, but may also be configured to direct a flow of coolant onto first and second end turn portions 40 and 41 of stator 24, or indirectly through housing 4 such as through a water jacket 125 as shown in FIG. 3 wherein like reference numbers represent corresponding parts in the respective views.

In accordance with an exemplary embodiment, electric machine 2 includes a temperature sensor 130, which, in the exemplary embodiment shown, is mounted to end wall 8 and directed toward magnets 90 of rotor 70. More specifically, temperature sensor 130 includes a non-contact sensing surface 135 that is directed toward magnets 90 of rotor 70. In accordance with one aspect of the exemplary embodiment, temperature sensor 130 takes the form of an infra-red temperature sensor, however, it should be understood that temperature sensor 130 can take on other forms of non-contact sensors. In addition, it should also be understood that non-contact sensing surface 135 could also be directed at lamination assembly 79 to detect a temperature of laminations 84. Temperature sensor 130 is linked to controller 114 though a sensing line 137. In this manner, controller 114 can control coolant delivery in electric machine 2 based on internal machine temperatures. By integrating the temperature sensor 130 into electric machine 2 and miming sensing line 137 through cable 99, cabling cost and complexity is reduced.

In further accordance with the exemplary embodiment shown, temperature sensor 130 includes a shield 140 having a deflector member 145 that extends entirely about non-contact sensing surface 135. Deflector member 145 guides any substances, such as coolant, away from non-contact sensing surface 135 to ensure that temperature sensor 130 obtains readings representative of rotor temperature. That is, the shield ensures that temperature sensor 130 senses temperatures associated with rotor 70 and not a temperature of other surfaces.

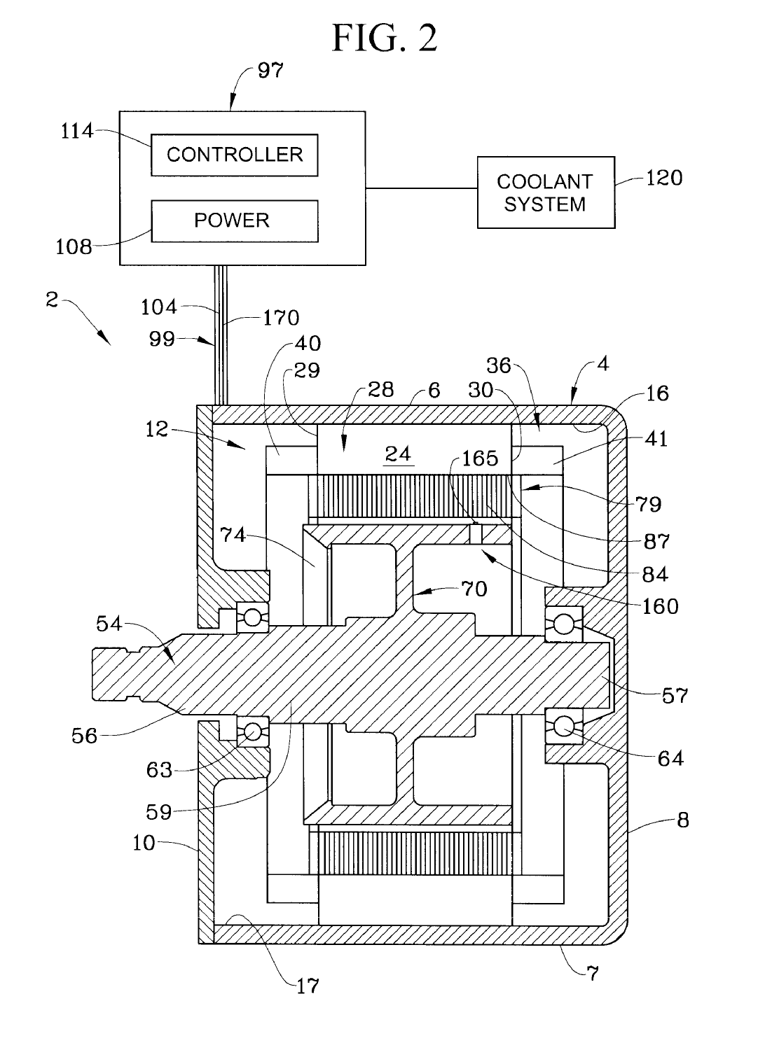

Reference will now be made to FIG. 2, wherein like reference numbers represent corresponding parts in the respective views, in describing a temperature sensor 160 in accordance with another exemplary embodiment. Temperature sensor 160 is integrated into hub portion 74 and includes a sensing surface 165 that is in direct contact with lamination assembly 79. That is, temperature sensor 160 senses a temperature of an unexposed surface of lamination assembly 79. More specifically, temperature sensor 160 detects a temperature of lamination assembly 79 and an interface region (not separately labeled) with hub 74. Temperature sensor 160 takes the form of a thermistor however other sensing elements, such as resistance temperature devices (RTD) may also be employed. In addition, the term “direct contact” should be understood to include contact through intervening materials. Temperature sensor 160 is linked to controller 114 through a sensing line 170 that passes through cable 99. In this manner, controller 114 can control coolant delivery in electric machine 2 based on internal machine temperatures. By integrating the temperature sensor 160 into electric machine 2 and running sensing line 170 through cable 99, cabling cost and complexity is reduced.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the claims.

What is claimed is:

1. An electric machine comprising:
a housing;
a stator mounted within the housing;
a rotor having a plurality of laminations rotatably mounted within the housing relative to the stator; and
a temperature sensor arranged within the housing, the temperature sensor including a sensing surface configured and disposed to detect a temperature of the rotor.

2. The electric machine according to claim 1, wherein the temperature sensor is a non-contact temperature sensor.

3. The electric machine according to claim 2, wherein the non-contact temperature sensor is an infra-red temperature sensor.

4. The electric machine according to claim 1, wherein the temperature sensor is in direct contact with the rotor.

5. The electric machine according to claim 4, wherein the temperature sensor is one of a thermistor and a resistance temperature device (RTD).

6. The electric machine of claim 1, further comprising: a shield including a deflector member positioned at the temperature sensor.

7. The electric machine according to claim 6, wherein the shield extends entirely about the sensor.

8. The electric machine according to claim 6, wherein the deflector member is arranged at the sensing surface of the sensor.

9. The electric machine according to claim 1, further comprising: a coolant system configured and disposed to direct a flow of coolant through the housing.

10. The electric machine according to claim 9, further comprising: a controller configured and disposed to deliver the flow of coolant through the housing based on temperatures sensed by the temperature sensor.

11. The electric machine according to claim 1, wherein the temperature sensor is configured and disposed to detect a temperature of the lamination assembly.

12. The electric machine according to claim 1, wherein the temperature sensor is configured and disposed to detect a temperature of magnets integrated into the plurality of laminations.

13. A method of operating an electric machine, the method comprising:
rotating a rotor relative to a stator; and
measuring a temperature of the rotor with a temperature sensor integrated into the electric machine.

14. The method of claim 13, further comprising: shielding a sensing surface of the temperature sensor.

15. The method of claim 14, wherein shielding the sensing surface of the temperature sensor includes deflecting coolant away from the temperature sensor.

16. The method of claim 13, wherein measuring a temperature of the rotor includes sensing a temperature of an unexposed surface of a plurality of laminations.

17. The method of claim 16, wherein sensing the temperature of the unexposed surface includes sensing a temperature of an interface between the plurality of laminations and a rotor hub.

18. The method of claim 13, further comprising: controlling delivery of coolant through the electric machine based on the measured temperature.

19. The method of claim 13, wherein measuring a temperature of the rotor includes detecting a temperature of a plurality of laminations of the rotor.

20. The method of claim 19, wherein measuring a temperature of the rotor includes detecting a temperature of magnets integrated into the plurality of laminations.
